(19) United States
(12) Patent Application Publication
(10) Pub. No.: US 2019/0172132 A1
(43) Pub. Date: Jun. 6, 2019

(54) SYSTEM AND METHOD FOR COMMON SPOTTING ACROSS MULTIPLE DEALERS

(71) Applicant: TradeWeb Markets LLC, New York, NY (US)

(72) Inventors: Christian Adam Bruner, New York, NY (US); Justin Daniel Peterson, New York, NY (US); Ian Stocks, Montclair, NJ (US)

(21) Appl. No.: 16/209,836

(22) Filed: Dec. 4, 2018

Related U.S. Application Data
(60) Provisional application No. 62/594,194, filed on Dec. 4, 2017.

(51) Int. Cl. G06Q 40/04

(52) U.S. Cl. CPC G06Q 40/04

(57) ABSTRACT

Computer implemented electronic trading systems and methods for spotting and hedging a plurality of electronic trades in order for multiple parties to execute and hedge the electronic trades at prices controlled by a common spot. The trading systems include one or more computer systems capable of, and the methods include steps for, collecting and analyzing a plurality of spot-designated electronic trades of a financial product that is traded with respect to a reference price of a reference financial product. The systems and methods determine a common spot for multiple electronic trades including one or more electronic trades of the financial product and one or more associated electronic trades of the reference financial product, and distribute instructions for the multiple electronic trades to be executed at prices controlled by the common spot. Some such trading systems, and related methods, are capable of determining multiple common spots for different electronic trades.

### CROSS REFERENCE TO RELATED APPLICATION

The present application claims priority to and the benefit of the filing date of U.S. Provisional No. 62/594,194, filed Dec. 4, 2017, which application is incorporated herein fully by this reference.

### BACKGROUND

The embodiments of the present invention relate to unique systems and methods for common spotting multiple financial products across multiple dealers.

When a customer trades, either buying or selling, a financial product with a trader or dealer, the trader or dealer typically will try to hedge the risk presented by the trade. In order to hedge their risk, a trader or dealer will try to buy or sell another financial product that presents an opposite risk. Where the financial product traded with the customer is one that is traded with respect to a reference price of a different financial product (“reference product”), the trader or dealer will try to oppositely buy or sell the reference product such that the risk presented by the trade with the customer is offset. One such financial product is a spread-quoted bond that is traded with respect to a reference price of a treasury benchmark bond such that the treasury benchmark bond is a reference financial product. Accordingly, from the trader's or dealer's point of view, when they buy a spread-quoted bond from a customer, they will sell the dollar value of one basis point (“DV01”) equivalent treasury benchmark bond at the bid price, and when the trader or dealer sells a spread-quoted bond they will buy the treasury benchmark bond at the offer price. This is traditionally referred to as “treasury hedging”. Similar processes may exist for other financial products as well. For other financial products, spotting can be defined as choosing the reference price(s) of any other market-determined inputs that are required, in combination with the quoted level, to determine the final agreed price of the quoted transaction.

When spread-quoted bond products are bought or sold they are quoted as the yield spread above a benchmark US treasury bond (sometimes referred to herein as a Treasury benchmark or Treasury). A treasury benchmark bond price and yield is typically agreed upon by the customer and trader or dealer for the purpose of establishing a spread-quoted bond price. This agreed upon, for example mutually acceptable, price and yield are collectively referred to as the treasury spot when established for the purposes of executing a trade of the spread-quoted bond along with executing a trade of the corresponding treasury benchmark. The process of setting a mutually acceptable price and yield for such purposes is referred to as spotting. For other financial products, spotting is more generally the process of setting mutually acceptable pricing components with such pricing components collectively referred to as spots of corresponding reference products such that the spots ultimately control the final agreed prices of the financial products. Such pricing components may include, product price, product yield, share price for a delta hedge of shares, dividend information, risk free rate information, or volatility information. In traditional trading systems of spread-quote bonds, a dealer attempting to hedge the risk presented by the trade of a spread-quoted bond must purchase or sell the treasury benchmark at the prevailing market price, and the spot of the spread-quoted bond will reflect the bid/offer spread of the treasury benchmark such that the price of the financial product is increased by the bid/offer spread. As a result, traditional trading systems result in increased cost to the buying party. For example, when a customer buys a spread-quoted bond from a dealer, the spread-quoted bond will be spotted at the offer price of corresponding treasury benchmark trade, and when a customer sells, the spread-quoted bond will be spotted at the bid price of the corresponding treasury benchmark trade. Accordingly, a need exists for a trading system and method of spotting trades with a spot that does not reflect the full bid/offer spread such that costs are reduced.

Furthermore, as part of traditional spotting processes for multiple customer trades, separate spots must be executed for each of the spread-quoted bond trades. For example, when customer seeks to buy a spread-quoted bond and sell a different spread-quoted bond with a dealer, multiple spots will be used. Not only do such traditional methods increase the resources required of the trade participants to acquire multiple spots, it also inherently involves a risk of the multiple spots being different, or there being a difference between the price resulting from the spot and the price achieved to hedge the underlying risk. When the spots of each trade are different, additional costs are realized for the buying customer and the dealer is unable to completely offset the risks. Accordingly, a need exists for a system and method of spotting multiple trades that does not require individualized spotting for each trade and thereby reduces the risks and costs involved in the trades. This is especially needed where a customer has both buy and sell trades across multiple counterparties and potentially incurs much unneeded costs in trying to obtain individual spots on the buy and sell side.

### SUMMARY

In view of the above discussion and the shortcomings in the prior art, the invention seeks to overcome such shortcomings of the prior art by providing technology offerings that ultimately facilitates the creation and use of a common spot across multiple trades involving multiple parties. Various embodiments of the present invention satisfy the foregoing, as well as other needs.

Embodiments of the present invention include systems and methods for spotting and hedging a plurality of parties for executing multiple electronic trades at a common spot. In an exemplary embodiment of the present invention, the trading system has the ability to collect electronic trades of a financial product that have been designated for spotting by a party and that have an associated reference financial product, determine net-eligibility of the collected electronic trades, net the net-eligible electronic trades, determine a reference product quantity corresponding to each netted electronic trade and a net quantity that is the sum of the reference product quantities, identify one or more sources to fill the net quantity, determine a net level for the net quantity, determine a common spot based on the net level, and distribute instructions to fill the multiple electronic trades each at one or more prices controlled by the common spot, where the multiple electronic trades include at least one netted electronic trade and at least one corresponding electronic trade of the reference product.

In one embodiment, a trading system includes one or more computer systems capable of spotting and hedging a plurality of electronic trades in order for multiple parties to execute and hedge the electronic trades at prices controlled by a common spot. The trading system further includes one or more account database for storing data representing a plurality of financial product electronic trades, where the plurality of financial product electronic trades includes a plurality of spot-designated trades between at least two parties. The plurality of spot-designated trades include data representing reference product information and data representing party information. The system also includes a plurality of user computers each in electronic communication with the trading system, where the plurality of user computers include a plurality of dealer computers each comprising an automated dealer trading system capable of sending data to and receiving data from the trading system, and a plurality of market participant computers capable of sending data to and receiving data from the trading system. The trading system is communicatively coupled to the user computers, the dealer computers, and the source computers, and the trading system is operative with programming to collect a plurality of spot-designated electronic trades, where the plurality of electronic trades include a first electronic trade having party information including a first party and a second party. The trading system is also operative with programming to determine an equivalent reference product quantity for at least one collected electronic trade, where the at least one collected electronic trade includes the first electronic trade, and determine net-eligibility of each of the collected electronic trades based on netting criteria. The trading system is further operative with programming to net the net-eligible electronic trades, determine a net quantity that is the sum of the reference product quantities corresponding to each of the netted electronic trades, and source the net quantity with one or more reference product trades sufficient to satisfy the net quantity based on source selection criteria, where at least one identified reference product trade involves a third party. The trading system is also operative with programming to determine a net level based on net level criteria and based on the identified one or more reference product trades. The trading system is also operative programming to distribute one or more instructions to fill the net quantity at the net level, determine a common spot based on the net level, and distribute one or more instructions to fill the multiple electronic trades each at one or more prices controlled by the common spot, where the multiple electronic trades include at least one netted electronic trade and at least one corresponding electronic trade of the reference product and the plurality of parties includes the first party, which includes a first market participant, the second party, which includes a dealer, and a third party, which includes a source.

In some embodiments, the trading system is further operative with programming to collect reference product price tolerance information of a market participant for a reference product corresponding to a collected electronic trade involving the market participant, collect reference product threshold information of a dealer for a reference product corresponding to a collected electronic trade involving the dealer, collect reference product quantity limit information of a source for a reference product corresponding to a collected electronic trade, and/or collect reference product level information of a source for a reference product corresponding to a collected electronic trade.

In certain embodiments, the net quantity is satisfied by one source, a reference product price tolerance information of the first market participant is satisfied by a reference product level of the one source, the equivalent reference product quantity of the first electronic trade satisfies a reference product quantity limit of the first dealer, the net level is equal to the reference product level of the one source, and the common spot is equal to the net level.

### BRIEF DESCRIPTION OF THE DRAWINGS

The foregoing summary, as well as the following detailed description of preferred embodiments of the application, will be better understood when read in conjunction with the appended drawings wherein like reference numerals refer to like components. For the purposes of illustrating the system and method of the present application, there is shown in the drawings preferred embodiments. It should be understood, however, that the application is not limited to the precise arrangement, structures, features, embodiments, aspects, and systems shown, and the arrangements, structures, features, embodiments, aspects and systems shown may be used singularly or in combination with other arrangements, structures, features, embodiments, aspects and systems.

The drawings are not necessarily drawn to scale and are not in any way intended to limit the scope of this invention, but merely to clarify a single illustrated embodiment of the invention. In the drawings:

FIG. 1 depict an exemplary schematic block diagram of a trading platform according to one embodiment of the present invention.

FIGS. 2-4 depict an exemplary netting of trades for a customer according to one embodiment of the present invention.

FIG. 5 depicts an exemplary display of the savings obtained by a customer according to one embodiment of the present invention.

### DESCRIPTION OF CERTAIN EMBODIMENTS OF THE INVENTION

In accordance with various embodiments of the invention, and as shown herein, various systems and methods are disclosed which enable the creation and use of a common spot across multiple dealers as part of simultaneously spotting a plurality of parties to multiple trades effectively as a common transaction with reduced risk and cost. As used herein, a customer means a market participant who is either buying or selling a financial product from or to one or more dealers or liquidity providers. Although discussed in terms of customers and dealer it will be appreciated by one of ordinary skill in the art that various embodiments of the present invention can be carried out as part of an advisor to advisor and need not involve a traditional customer or dealer. A trader may conduct trading by using an associated dealer as an intermediary. Accordingly, a trader means a market participant who is either buying or selling the financial product while also hedging those trades with trades of an offsetting reference product. A dealer may buy or sell the reference product from or to another dealer, as well as may provide a trading desk for traders to utilize to conduct trades with other traders, customers, and/or dealers. As used herein, a dealer means an entity representing the trading desk through which a trader is buying or selling a financial product with a customer, and/or an entity that is buying or selling a reference product from or to another dealer. A dealer may be a liquidity provider. Although some embodiments are described herein in terms of corporate bond trading and corresponding treasury benchmark bond trading, in various embodiments the invention is applicable to all financial products, which may be traded with respect to a price of another financial product (“reference product”) and all financial products where the final price for the initial transaction is not known until a reference price for an offsetting trade (i.e., a hedge) of a reference product is established. For example, spread-quoted financial products. Accordingly, as used herein spread quoted bond (SQB) is interchangeable with financial product, and treasury benchmark bond (treasury) is interchangeable with reference product.

In general, a computerized electronic trading system according to one embodiment of the present invention enables a customer's buying and selling of spread-quoted bonds to one or more dealers utilizing a common spot across the resulting set of transactions. Once the spotting is performed, meaning that all of the spread-quoted bond (“SQB”) trades have been spotted and individual treasury hedges have been established, the trades may be processed at final prices acceptable to all parties. This interaction between market participants is preferably achieved across an electronic marketplace (i.e., trading platform), which may consist of various computers which run applications dedicated to several functions such as market creation and management (e.g., order book management, market data dissemination, trading protocol management, information storage, etc.). Such trading platforms have been described, for example, in U.S. Pat. No. 7,433,842, entitled METHOD AND SYSTEM FOR EFFECTING STRAIGHT-THROUGH-PROCESSING OF TRADES OF VARIOUS FINANCIAL INSTRUMENTS, which issued Oct. 7, 2008 and was filed Mar. 25, 2004 as U.S. patent application Ser. No. 10/808,820, the entirety of which is incorporated herein by reference.

In an exemplary embodiment, the system architecture of the computerized electronic trading system and method includes hardware, system software and application software. The system hardware may include one or more computers each having at least one processor and memory. The system hardware may additionally include other components such as storage and network components (i.e., servers, routers, switches, data buses, databases, etc.), networked to the computer and any external connections or in the form of distributed computers across data centers as would be understood by a person of ordinary skill in the art having the benefits of the present disclosure.

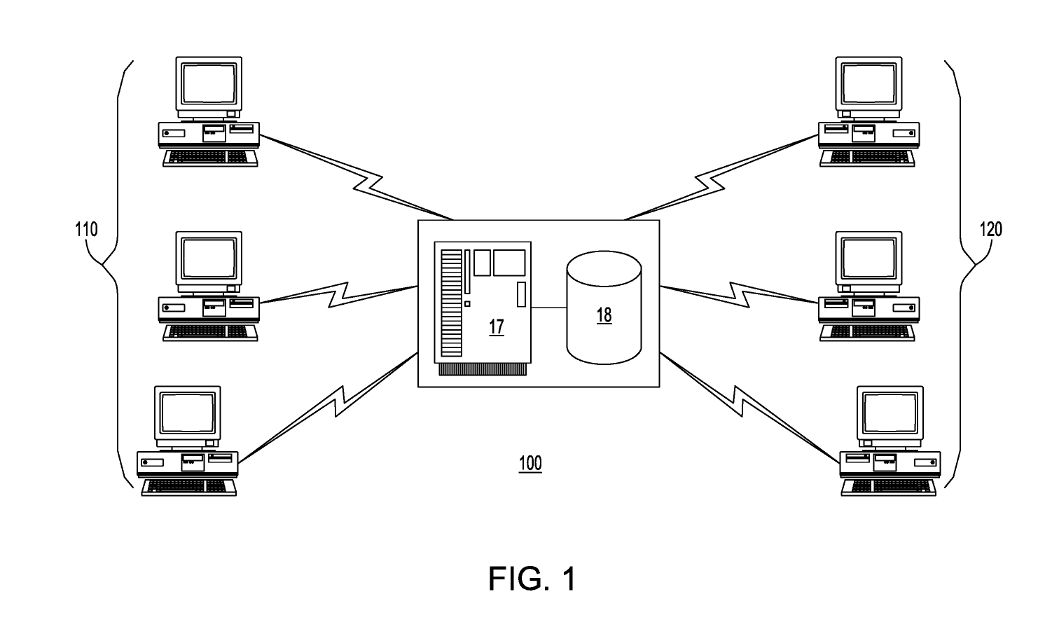

In an exemplary embodiment, a computerized electronic trading system and method includes a central trading system, a trading platform and a plurality of user (customer, dealer, trader) computers through which the customers and dealers may process their trades. For example, FIG. 1 shows an exemplary embodiment of a trading system 100 in communication with various customer computers 110 and dealer computers 120. Trading system 100 preferably includes one or more computer systems 17 that may include one or more software modules, databases 18 and related database management systems. In some embodiments, the one or more software modules may include a collecting module, a netting module, a sourcing module, a spotting module and a distribution module, as will be described in more detail below. Customer computers 110 may also typically connect to or include an Order Management System (“OMS”) to assist in the execution and trading of securities. Various input and output devices are preferably provided with the customer computers 110 and dealer computers 120 including, by way of non-limiting example, a display (e.g., liquid crystal display (LCD)), and an input device (e.g., a keyboard, mouse, touch pad, or light pen). In some embodiments, the system includes source computers. Preferably, an Application Programming Interface (“API”) is used to connect the dealer and customer to the electronic trading system and perform certain tasks automatically. For example, an API may be utilized by a customer to connect their system with the electronic trading system for the purpose of sending instructions, such as orders, which may eventually be converted for the dealer. Dealers may connect to the central trading system via an API for the purpose of providing the trading system with information, for example by having an automated dealer trading system communicatively coupled to the central trading system. The customer and dealer computers 110 and 120 also preferably include a storage device such as, for example, a magnetic disk drive and magnetic disk or other equivalent device. The specific hardware combination/configuration is not crucial to the instant invention, and may vary as a matter of design choice within the functional parameters disclosed herein. Users (customers, dealers, and traders) of the trading system 100 typically interact with the Graphical User Interfaces (“GUI's”) displayed by the software modules by “clicking” on numbers or graphics (e.g., buttons) that are displayed on the GUI's. Persons of skill will understand that the present invention is not limited to clicking with a computer mouse, but includes use of any other device for indicating an action with graphics-based software. Although discussed in terms of customers and dealer it will be appreciated by one of ordinary skill in the art that various embodiments of the present invention can be carried out as part of an advisor to advisor or other platform and need not involve a traditional customer or dealer.

According to one embodiment of the present invention, customers and dealers follow the below described process to complete their treasury hedging. In one embodiment of the present invention the spotting is completely automated through computer systems 17. After yield spreads to treasury benchmarks have been agreed for multiple SQB electronic trades, and a dealer or trader desires to hedge those SQB trades with equivalent electronic treasury benchmark bond trades (“Treasury hedge”), a customer may initiate the spotting process in order to spot each of the trades by designating the trade for potential spotting. As can be appreciated by one of ordinary skill in the art designating trades for spotting may be performed automatically without any required human interaction, for example based on pre-set user settings which may include a particularly scheduled time. In various embodiments of the present invention, initially to facilitate the spotting process, specific trades are selected for spotting by a customer or a group of customers, and/or by a dealer or a group of dealers, each may do so utilizing a specialized GUI. In some embodiments, the party to the SQB trade that is selling the SQB is the party that may designate the SQB trade for spotting. All of the spot-designated trades are then automatically collected by the trading system for potential inclusion in the spotting process. In one embodiment, a user of the system may establish defaults or other criteria for automated selection of trades for spotting. The system may then simultaneously spot and hedge each of the trades or some of the trades, as will be discussed in more detail below. As can be appreciated by one of ordinary skill in the art, there are numerous methods and systems to collect the trade information without departing from the scope of this invention.

One embodiment of the present invention is a computer implemented electronic trading system which simultaneously spots multiple trades between multiple parties by collecting spot-designated trades, determining net-eligibility of each spot-designated trade, determining a net-hedge level, and determining a common spot for multiple trades. The system automatically collects SQB trades that have been designated for spotting. In some embodiments, the trading system includes a collecting software module (“collecting module”) configured to collect spot-designated electronic trades, as well as associated data and/or information, from the customer computer, dealer computer, trading platform, system databases, and/or other communicatively coupled resource. Preferably each spot-designated electronic trade includes data that represents SQB information, equivalent treasury information, and party information, although additional data and information may be included as well. Numerous parties (customers, dealers and traders), may be involved in a common-spotted transaction of numerous trades. For example, over twenty parties may be included where the systems and methods of the present invention simultaneously create a common spot for use in fifteen trades of corporate bonds and twelve trades of treasury benchmark bonds between a plurality of parties made up of six customers, nine dealers and twelve traders. It should be understood that these numbers of trades, customers, dealers and traders simply serves as an example and should not be understood as limiting in any manner.

Once the system has collected spot-designated trades, the system determines the net-eligibility of each trade. In some embodiments, the trading system includes a netting software module (“netting module”) configured to determine net-eligibility of collected trades, net the net eligible trades, determine treasury quantities, and determine net quantities. In some embodiments, the system groups the spot-designated trades according to the equivalent treasury benchmark for each trade, such that grouped trades have the same equivalent treasury. The system calculates the DV01 equivalent treasury hedge quantity (“Treasury Quantity”, also referred to as “treasury risk” or TSY RISK) for each trade by utilizing a Treasury Market Price obtained or calculated by the system. The Treasury Market Price may be a prevailing Treasury Composite Price for a Treasury. For example, the system may aggregate treasury prices from automated trade systems of multiple dealers that are communicatively coupled to the system, analyze Treasury pricing feeds from dealers over a period of time, analyze Treasury trades that have occurred on the trading platform of the system, or other price source, or use the treasury price at which the parties agreed to the collected SQB trades. Treasury price information may be within the electronic trade data as part of the SQB information. In some embodiments, the trading system, such as the collecting module, is configured to collect all needed information used by the system from communicatively coupled resources.

Once the system has determined a Treasury Quantity (also referred to herein as “treasury position”) for each trade, the system may automatically determine net-eligibility based on netting criteria. In some embodiments, a party, such as a dealer, may designate a trade for hedging or may designate a trade as not to be hedged, and if the trade is designated as not to be hedged the system determines it is not net-eligible. In some embodiments, the system, for example the collecting module, may be configured to collect hedge threshold information from a party, such as a dealer, where the hedge threshold information corresponds to a trade the party has designated for hedging, and if the calculated Treasury Quantity for the equivalent treasury satisfies the hedge threshold the system determines it is net-eligible. In some embodiments the hedge threshold is a minimum quantity. Other netting-criteria may include a determination of whether there are multiple collected trades having treasury information of the same treasury benchmark. As can be appreciated by one of ordinary skill in the art, determining whether a trade is net-eligible may be determined using various criteria, determinations, or logic.

The system then determines the net-hedge quantity (“Net Quantity”) of the individual net-eligible trades, which is the sum of the Treasury Quantities corresponding to the individual net-eligible trades. The Net Hedge Quantity or Net Risk per Dealer (“Dealer Quantity”) is also similarly calculated. For example, as will be described in more detail, the Treasury Quantity of multiple trades may be allocated to a single dealer to ultimately be executed with one or more traders associated with that dealer or may be allocated among multiple dealers or market participants.

Once the computer system 17 automatically collects and nets the Treasury Quantity of all of the net-eligible trades to a Net Quantity (also referred to as “net treasury position”), the system automatically determines a Net Level. The Net Level is the price and yield at which the Net Quantity is traded (also referred to herein as the Net Hedge) The system conducts a sourcing process to identify one or more sources to fill the Net Quantity in one or more trades of the treasury based on source selection criteria. In some embodiments, the system includes a sourcing software module (“sourcing module”) configured to identify and select one or more source to fill the Net Quantity, and determine a Net Level, as described herein. In some embodiments, the one or more sources are dealers (“net-dealers”). In some embodiments, the one or more sources are one or more dealers involved in one or more of the netted trades. In some embodiments, the one or more sources are liquidity pools. In some embodiments, the one or more sources are liquidity providers other than dealers. In some embodiments, the system sources the Net Quantity on a trading platform, for example in the name of the party who is performing the spotting, and then may intermediate between all the dealers allocated a Treasury Quantity. In some embodiments, if the Net Quantity is significantly large, the system may source the equivalent of the Net Quantity in the a different market, such as a futures market when treasury is the reference product of the trades and then effect futures-to-cash basis trades between one or more dealers in order to deliver the proper Treasury hedge quantity to each dealer for the trades selected for spotting. In some embodiments, the selection criteria involves a reference product quantity limit that the system, for example the collecting module, is configured to collect from a source, such as a source computers. Preferably, the trading system identifies a source as a primary source, based on determining the source's treasury quantity limit is not surpassed by the entire net-treasury hedge quantity (i.e., Net Quantity). In some embodiments, if a primary source is not identified, the system then identifies multiple sources that are capable of jointly filling the Net Quantity based on the multiple sources treasury quantity limits. As can be appreciated by one of ordinary skill in the art, identifying which source or sources are capable of filling the Net Quantity may be based on various criteria or logic. Additionally or alternatively, market participant themselves can be used in lieu of or in addition to dealers and market liquidity pools can be identified as well. In one embodiment, the equivalent futures risk in the market can be obtained and a futures-to-cash spread trade in the equivalent risk can be performed with one or multiple liquidity providers. In some embodiments, the trading system automatically identifies any treasury trades (i.e., trades of the treasury benchmark bond that are not a direct counterpart hedge to an SQB trade) that are between dealers (also referred to herein as dealer-to-dealer) or between traders at a shared dealer (also referred to herein as intra-dealer).

Once a primary source, or multiple sources are identified as capable of filling the Net Quantity, the system determines the price and yield (“Net Level”) that will be used to execute one or more treasury trades to fill the Net Quantity based on Net Level criteria. In some embodiments, the net-level is the price and yield at which a primary source is willing to fill the Net Quantity. In some embodiments, the Net Level is determined based on the various prices and yields at which multiple sources may jointly fill the Net Quantity. In some embodiments, the system, for example the collecting module, is configured to collect customer threshold information (also referred to herein as “price-tolerance”) corresponding to the Treasury, which is considered as part of determining the Net Level at which the Net Quantity is filled. Preferably, the net level criteria requires the Net Level satisfy the customer threshold information. In some embodiments, the customer threshold information represents an amount of deviation from the Treasury Market Price that is acceptable to one or more customers. In some embodiments, the customer threshold information represents an amount of deviation from the treasury price and yield of the agreed SQB trade designated for spotting. As can be appreciated by one of skill in the art, the net level criteria may include various criteria, determinations, and/or logic.

Once a net-level is established, the system determines one or more Treasury levels (price and yield of the treasury) for the Dealer Quantities. In some embodiments, the system includes a spotting software module (“spotting module”) configured to determine and generate the Treasury Levels, common spots, spots, and other information needed for establishing the electronic trades of financial products and reference products, as described herein. The Treasury level may then be used to set the spot of the treasury hedges, and set the levels of any treasury trades (i.e., non-hedging treasury trade) needed to hedge all parties. In one embodiment, the system intermediates and allocates the individual treasury hedge quantities among the identified dealers, for example by distributing instructions, such as trade orders (“Fills”), to the dealers for the respective Dealer Quantity at one or more Treasury levels (i.e., price and yield) that are determined based on the Net Level. In some embodiments, the system includes a distribution software module (“distribution module”) configured to generate and distribute to various parties, such as communicatively coupled computers, instructions, such as but not limited to, fill orders, sell orders, buy orders, and settlement instructions, to execute the determined and/or requisite transactions. In some embodiments, once the Net Level is calculated, the system allocates treasury trades internally between traders at the dealer and allocates treasury trades between the dealers such that identified dealer-to-dealer trades and/or intra-dealer trades are intermediated to complete the allocations and result in a spotting of all the hedge trades at the same common-spot. Once Treasury levels are determined, the system may spot the treasury hedges simultaneously or in a manner that is viewed as being simultaneous to the counter parties. For example, in some embodiments, the Treasury level of each Dealer Quantity is the same as the Net Level. In some such embodiments, a single common spot equal to the Net Level is utilized for all treasury hedges and the Net Level is utilized for all treasury trades. In other embodiments, the Treasury level for each Dealer is different and determined based on the Net Level (such as a weighted calculation based on Dealer Quantity, or other similar calculation), such that the proceeds of filling all Dealer Quantities equals the proceeds of filling the Net Quantity, which results in dealer specific common spots. As can be appreciated by one of skill in the art, any calculation, criteria or logic may be used to determine Treasury levels for each dealer.

Regardless of whether the resulting Treasury level is common across dealers or dealer specific, Treasury levels are used to fill treasury trades and set a common spot for the Treasury hedges simultaneously or in a manner that is viewed as being simultaneous to the counter parties. In some embodiments a common spot may be the same as the Net Level. In some embodiments, the trading system may further allocate individual treasury hedge quantities to individual traders associated with each dealer and distribute instructions, such as Fills, at a common spot for executing each individual treasury hedge. In doing so, each side of each treasury hedge involving a trader, or trader at a dealer, is spotted at a common spot. As will be discussed in more detail below, the common spot controls the ultimate price of the corresponding SQB trade. As a result, in both situations of a single common spot and dealer specific common spots, a benefit of the invention is realized by the customer. From the customer's perspective the trades that have been netted and there is no need for the customer to pay the Bid/Offer spread that would have been needed to be paid if common spotting was not performed. For example, as is described in more detail below, if a customer has buy and sell SQB trades and the net treasury position of the customer is “buy”, the customer will be spotted on the offer side of the treasury benchmark for both of his or her buy and sell SQB trades. This causes the customer to not pay the full bid/offer spread for the sell trades as would have been required if a traditional trading system was used, and as such the total cost of the trades is reduced. This results in both a time and cost savings for the customer. Furthermore, as will be discussed in more detail below, a dealer or trader will have the entire risk of the SQB trade offset as a result of the system creating a common spot that controls the ultimate price of the SQB Trade and the ultimate price of the corresponding equivalent benchmark treasury bond trade (i.e., hedge).

More specifically, in a situation where a customer needs to spot multiple SQB trades, each having the same equivalent treasury benchmark, across multiple traders and dealers, in traditional trading systems the customer would have been required to spot each trade separately which would commonly result in increased risk to dealers and increased cost to customers when the resulting spots were different based on the timing of each individual spot. Conversely, according to one embodiment of the present invention, a single common spot is calculated by the system for each spot-designated trade, which are then utilized to control the ultimate price of each SQB trade and the ultimate price of each corresponding treasury hedge, such that the cost to the buying party is reduced and the risk of the hedging party is entirely offset.

In one embodiment, which provides the previously described result, the system collects multiple spot-designated SQB trades from a customer. At least one trade involves a different trader at a different associated dealer than another trade. The system automatically collects SQB trade information, including SQB information, such as financial product, equivalent treasury benchmark bond information, and party information. The system also collects treasury hedge threshold information and customer price tolerance information. The system automatically determines that all collected trades have the same equivalent treasury benchmark bond, and have been designated for hedging by the respective traders and/or dealers. The system then may automatically determines an equivalent Treasury Quantity for each trade and determines the Treasury Quantity of each trade that is above each respective trader/dealer's hedge threshold, and as such are each collected trade is determined net-eligible. The system may then determine a Net Quantity of the net-eligible trades, and determine a net treasury quantity for each dealer. The system may then identify all resulting dealer-to-dealer and intra-dealer treasury trades. The system collects source price and yield information, as well as source treasury quantity limit information. The system then automatically sources the Net Quantity by identifying a primary net-dealer to fill the Net Quantity based on the Net Quantity being below the primary net-dealer's treasury quantity limit. The system determines the price and yield of the net-dealer for the Net Quantity by determining that the source price and yield information satisfies the customer's treasury price-tolerance, and sets the Net Level at the primary net-dealer's price and yield. The system then distributes instructions for a Fill to the primary net-dealer for the Net Quantity at the Net Level. The system then determines the Treasury Level for each dealer that is equal to the Net Level based on Dealer Treasury Level criteria, and determines a single common spot for all treasury hedges that is equal to the Net Level. The system then allocates and distributes Fills for all trades simultaneously or in a manner that is viewed as being simultaneous to the parties. The system intermediates each dealer-to-dealer treasury trade and distributes Fills to each dealer for the dealer-to-dealer trades at the Treasury level and distributes Fills to each dealer for all intra-dealer treasury trades at the Treasury level. The system distributes Fills to all customers, traders, and/or dealers for the treasury hedges at the single common spot. As will be discussed in more detail below, the common spot controls the resulting SQB price and the resulting Treasury price. As a result of the system using the net-dealer's treasury quantity limit to select a net-dealer, the customer's price threshold information and net-dealer's price and yield to determine a net-level, and the dealer's hedge threshold information to determine net eligibility, each of the customer's, dealers', and net-dealer's preferences are linked to the Net Level and resulting common spot, such that instructions for all trades are distributed to the parties at mutually acceptable prices and yields controlled by the Dealer Treasury Level and common-spot, which in turn are controlled by the net-level. Accordingly, the system according to one embodiment of the present invention is able to link multiple parties preferences to simultaneously spot multiple trades at a common spot such that the costs to the customer are reduced and the risks to the dealer are offset.

In some embodiments, based on the spotting, each SQB trade, regardless of buy or sell, will be spotted at a common spot that is equal to the net level that the net-hedge quantity was traded on. As a result, for the buy and sell SQB trades that have been netted, the customer does not need to pay the full Bid/Offer spread. Moreover, in one embodiment, the spotting and hedging is done simultaneously so that there is no chance that the spot used for each SQB trade and each Treasury trade will be different. As will be discussed in more detail below, the spot price of the SQB trade is calculated using the common spot, such that the common spot controls the spot price of each SQB trade and the spot price of each Treasury trade.

As an example of one embodiment, if the net hedge quantity is 5MM 10 year notes and 3MM is to hedge US Credit trades with dealer A, the whole 5MM is executed with dealer A's treasury desk. The trade is executed at one price using the treasury composite price as a target with a price tolerance that may preferably be specified by the customer per treasury benchmark. There is no need for any customer interaction once the specialized computer system is pre-configured with the customer's desired treasury benchmark price tolerance.

In one embodiment, if the entire net-hedge quantity can be executed with the treasury desk of a single net-dealer (i.e., the dealer with the largest net position, the “primary dealer”), it is then distributed to the other identified dealers that are to be involved in the net hedge. This may be accomplished with a series of automatically generated dealer-to-dealer trades within the trading system. For example, if the net-hedge quantity of 5MM can be executed with Dealer A; and Dealer A only needs 3MM to hedge; the other 2MM is transferred through the trading system to Dealer B and Dealer C (e.g., 1.5MM net hedge for Dealer B and 0.5MM net hedge with Dealer C). If for some reason, the whole net treasury hedge trade of the Net-Hedge Quantity cannot be executed with a single source, the trading system will satisfy the net-hedge quantity competitively with multiple sources to achieve the best price among the other sources. As can be appreciated by one of skill in the art, determining the best price among multiple sources can be based on various determinations, criteria, and/or logic.

At each dealer, treasury quantities of the net hedge trade are further distributed to individual traders to hedge the trades that were executed with the corresponding customer(s). In one embodiment, similar to the dealers, trader criteria may be used to determine which trader receives the entire hedge quantity (i.e., the trader with the largest position) and then automatic transfers are made to other traders on the desk using intra-desk trades generated by the spotting process. For example, if the net hedge quantity of 3MM was to Dealer A, it may be partitioned and distributed to Trader A who only needs 1MM to hedge; the other 2MM is transferred through the trading system to Trader B, Trader C and Trader D (i.e., 0.75MM net hedge for Trader B, 0.75MM net hedge for Trader C and 0.5MM net hedge for Trader D). As can be appreciated by one of skill in the art, various trader criteria or logic may be used.

Once the net hedge trade quantity has been distributed, using the information from the spotting process a reference product trade price (also referred to herein in as Treasury price) is determined from the common spot, and a financial product trade price (also referred to herein in as SQB price or Credit price) is calculated using the reference product trade price. In some embodiments, the Treasury price is used to calculate the treasury yield. The credit yield is equal to the sum of the Treasury yield and the credit spread. The credit yield is then used to obtain the credit price as explained below. Once the financial product price is calculated, the trades are finalized and electronically communicated to the counterparties.

An example of calculating the price of a spread-quoted bond will now be explained in more detail. For the below example, a credit trade has been executed with the below agreed upon spread and treasury spot price:

| Corporate Bond: AAPL | Treasury Benchmark: 30 yr T |
|---|---|
| Coupon: 4.25% | Coupon: 2.75%, |
| Maturity: Feb. 9, 1947 | Maturity: Aug. 15, 1947 |
| Spread: 100 bps (1%) | Spot Price: 95.101 |
| Face: 100 | Face: 10 |

In order to calculate the price of the corporate bond AAPL, first the treasury yield is calculated. Because the cash flows (2.75% coupon) and present value (95.101) of the treasury benchmark are known, the treasury yield can be derived by solving for the internal rate of return. In this example the treasury yield is 3%. Next the AAPL bond credit yield is calculated by summing the treasury yield and the spread=3%+1%=4%. The price can then be calculated using this information. The AAPL bond price is the present value of the bond's cash flows. The AAPL bond's cash flows are the 4.25% coupons and the face value of 100 at maturity. The discount rate is the yield, calculated above (i.e., 4%). With the discount rate and cash flows known, the AAPL bond's price can be calculated using a discounted cash flow approach. Namely the AAPL bond price is 104.24.

In one embodiment, credit trades of corporate bonds that were deemed to not be eligible for netting may then be hedged individually by executing and pricing the corporate bond trade in a similar manner to the executing and pricing that was discussed above in the AAPL corporate bond example. Since these trades are not netted, they will not necessarily be at the same price as the netted trades.

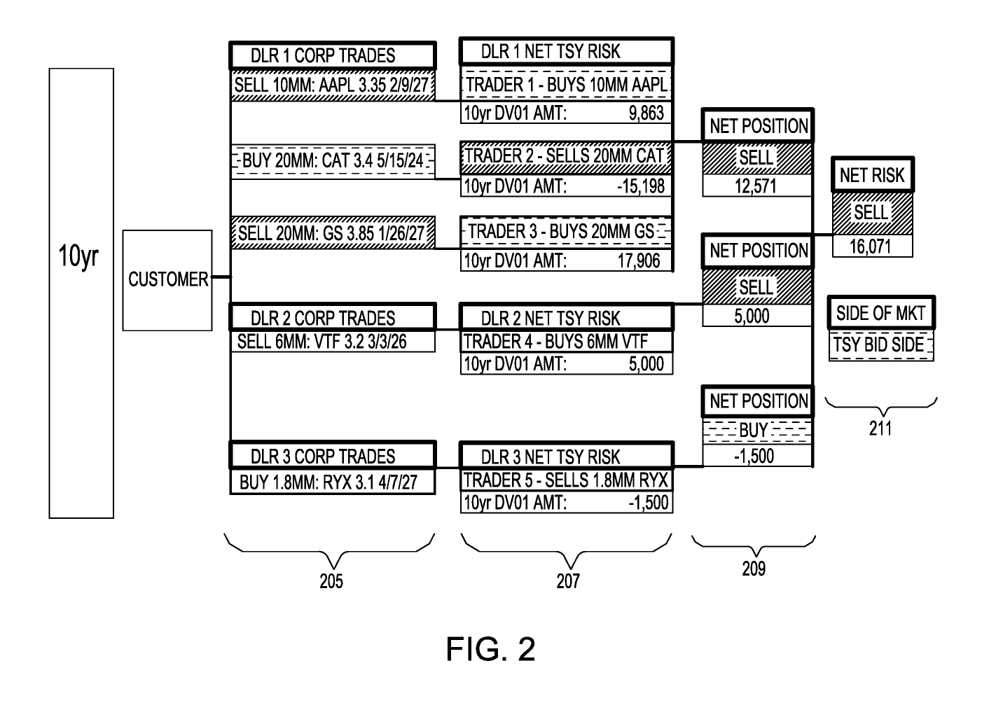

Another example of the netting process will now be explained with reference to FIGS. 2-4. As can be seen in FIG. 2, in this example, a customer has executed a mix of buy and sell corporate bond trades (CORP TRADES of SELL 10MM: AAPL 3.35 2/9/27; BUY 20MM: CAT 3.4 5/15/24; SELL 20MM: GS 3.85 1/26/27; SELL 6MM VTF 3.2 3/3/26; BUY 1.8MM RYX 3.1 4/7/47) with multiple dealers (i.e., DLR 1, DLR 2, DLR 3) and with multiple traders across the dealers (i.e., TRADER 1, TRADER 2, and TRADER 3 each at DLR 1; TRADER 4 at DLR 2; TRADER 5 at DLR 3). Each of these corporate bonds has the same treasury bench mark (i.e., 10 yr, which stands for 10 year Treasury). This example more clearly shows how utilizing the present invention results in improved spotting for the customer, and with no risk to the dealer.

As shown in FIG. 2, the treasury risk (TSY RISK, or Treasury Quantity) is determined for each trade by the system calculating the DV01-equivalent treasury quantities (DV01 Amt). Column 205 shows the customer trades to be spotted. The Net Treasury Hedge Position (NET POSITION) for DLR 1 (also referred to herein as Net Hedge Quantity of a Dealer) across the traders as shown in column 209 is sell 12,571, for DLR 2 it is sell 5,000 and for DLR 3 it is Buy 1,500. This is based on the aggregation of the Net TSY Risk as shown in column 207. Aggregation of the treasury risk occurs between traders at the dealer level and then between dealers. The net treasury risk amount (net risk, also referred to herein as Net Hedge Quantity) results in a sell position of 16,071 for the dealers as shown in column 211.

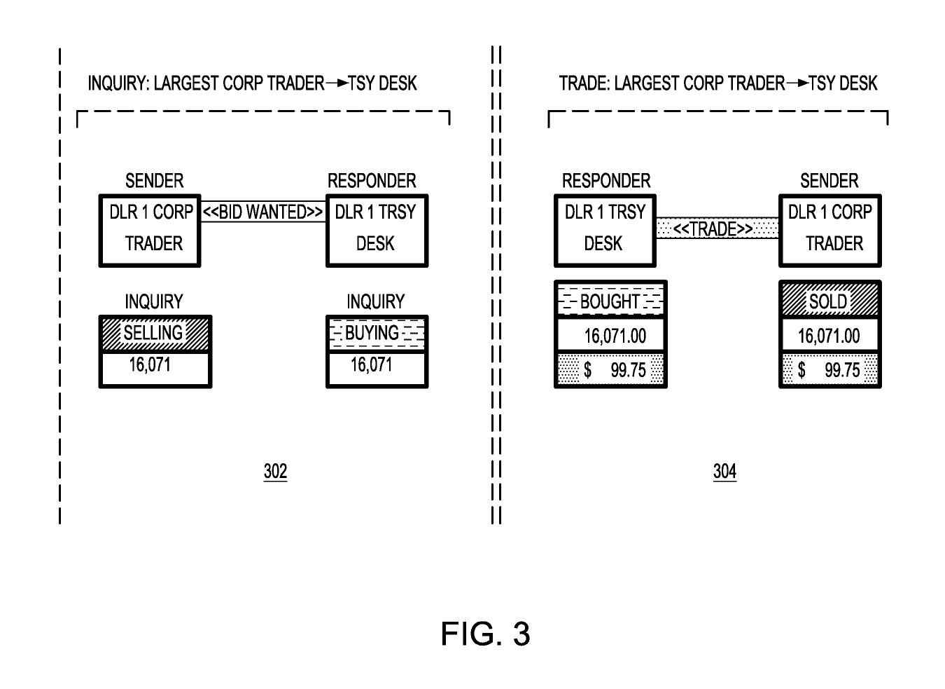

As shown in FIG. 3, in this example the net treasury risk amount calculated (i.e., 16,701) is executed by the corporate trading desk (CORP TRADER) of the dealer with the largest treasury risk, which in this example is DLR 1. As discussed above, different criteria, other than largest treasury risk may also be used to select a dealer's execution desk. In this embodiment the trading system first tries to fill the net treasury risk with the dealer's treasury desk as shown in column 302 by sending an inquiry to its treasury desk. If the net treasury risk cannot be filled by the associated dealer's trading desk the trading system attempts to fill the net treasury risk with a competitive trade on the trading system's trading platform. As can be seen in 304, the sell order of 16,071 10 year Treasury is filled by the treasury desk (TRSY DESK) of DLR 1, at the spot price of $99.75. The acceptability of this spot-price may be established based on a pre-defined pricing tolerance of the customer.

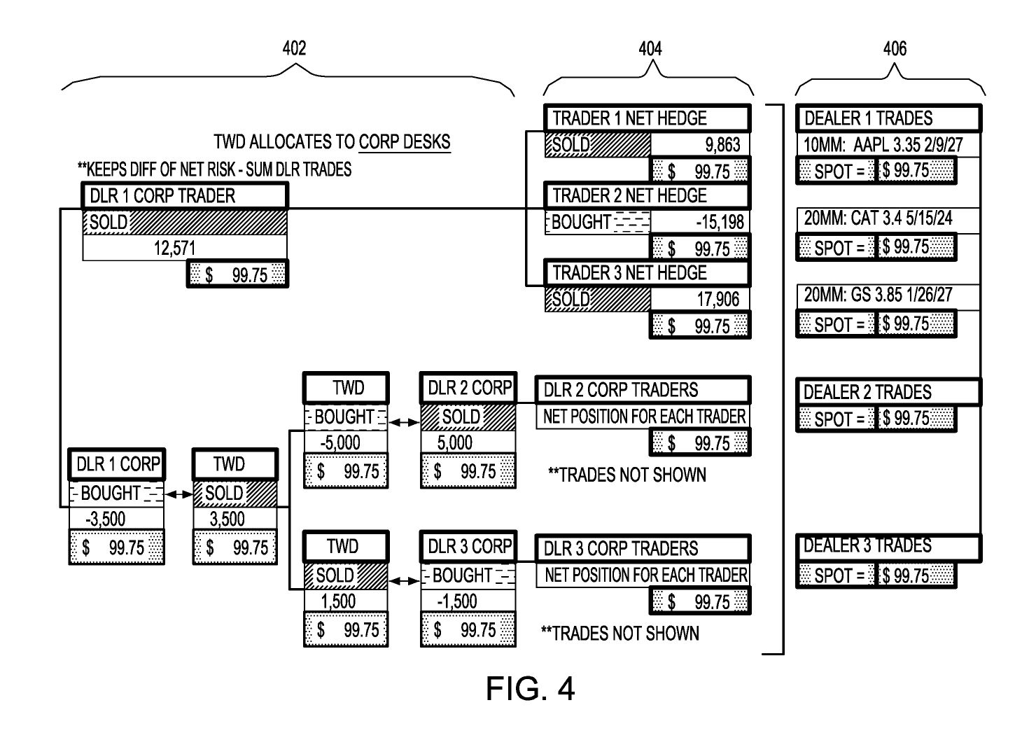

As can be seen in FIG. 4, in a further embodiment, once the sell order has been designated as filled, it needs to be allocated among all of the traders and other dealers identified by the trading system. Once the order is filled, as can be seen in dealer trade allocation 402, DLR 1 holds the entire net treasury hedge position. The system automatically allocates the treasury hedges (also referred to herein as Treasury Quantities), as shown in trader allocations 404, to each of DLR 1's individual traders involved in the trade as needed to satisfy the net-hedge. Namely, 9,863 sell for Trader 1, 15,198 buy for Trader 2, and 17,906 sell for Trader 3. All of which trades at the established common-spot price of $99.75. This leaves DLR 1 with a buy of 3,500 which needs to be allocated among DLR 2 and DLR 3 to establish the correct hedge. To facilitate this, the trading system (TWD) buys 5000 from DLR 2 and sells 1,500 treasury benchmark bonds from DLR 3 and sells to DLR 1 accordingly. This results in each dealer being properly hedged. The system then permits DLR 2 and DLR 3 to allocate among their traders as needed. As shown in column 406, the customer is spotted at 99.75 for all trades, including the netted down buy trades. Since the net spot was sell, the customer does not have to pay the treasury bid/offer on the spots for offsetting buy trades.

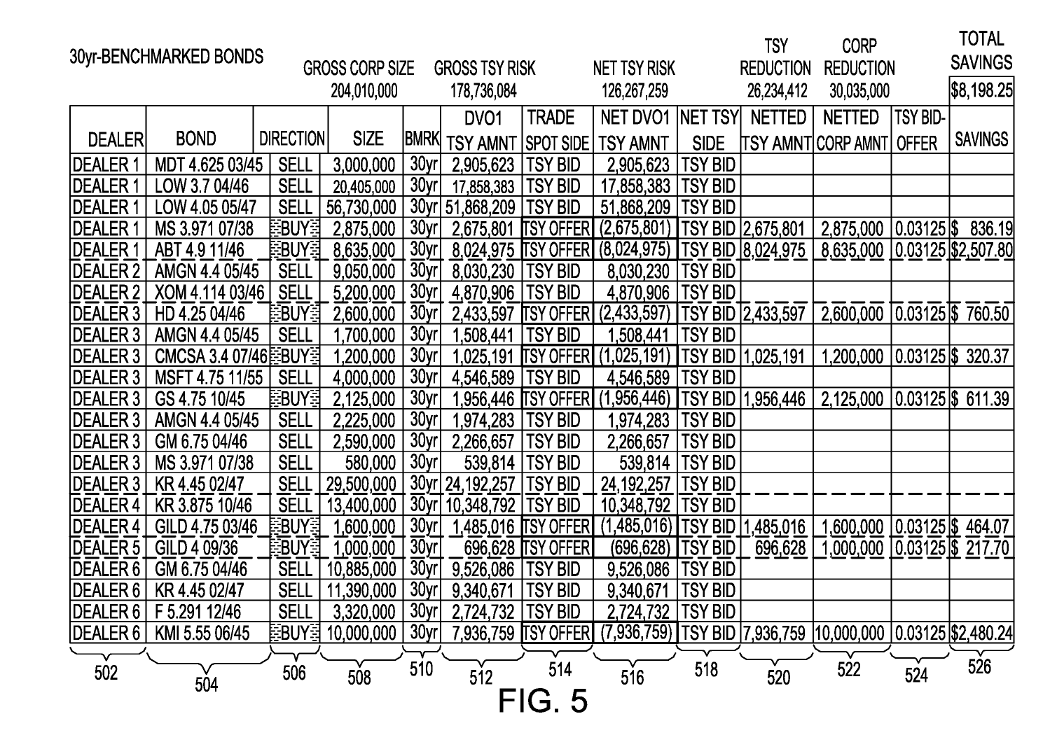

FIG. 5 illustrates an exemplary scenario where a customer would realize significant saving utilizing the above discussed system and method. All spread-quoted bond trades for a customer, each SQB trade having a given treasury benchmark equivalent (i.e., 30 year), across all Dealers are shown in FIG. 5. Column 502 indicates the dealer name, Column 504 indicates the bond being traded, column 506 indicates which side of the trade the dealer was on, column 508 indicates the size of the trade, column 510 indicates the benchmark, which in this particular example is 30 year, column 512 indicates the DV01 treasury amount, column 514 indicates which side of the treasury spot that party is on, column 516 indicates the Net DV01 Treasury amount, column 518 indicates the Net Treasury side, column 520 indicates the netted treasury amount, column 522 indicates the netted corporate amount, column 524 indicates the treasury bid offer and column 526 indicates the monetary savings for the customer. Initially the DV01-equivalent treasury hedge quantity is calculated by utilizing bond analytics pricing libraries, which handle all the variable type of bonds traded on the trading system, using market standard formula for DV01 as can be appreciated by one of ordinary skill in the art. The “Net Treasury Risk” (also referred to herein as Net Treasury Quantity) is calculated by netting the DV01-equivalent treasury hedge quantities for all buys and sells across all dealers. The direction of the Net Treasury Risk determines the direction/side of the Treasury Market used for all spots and hedges. As discussed above, for any trades that have been “netted”, the customer will not have to pay full Bid/Offer on those spots. The “Total Savings” reflects the amount of money saved by not paying full bid-offer on the spots of the netted trades.

In some embodiments, the API may be utilized by the customer to receive post trade messages for the purpose of automatically booking trades into the customer's system. Additionally, the API may also be utilized by the dealer to receive post trade message to facilitate automatic trade booking at the dealer site.

It should be noted that although the embodiments described may use multiple software modules for performing the various functions of the system, other embodiments could be implemented using any number of modules, with any single module incorporating the functions of several, or all, of the modules. The precise design of the software and the programming language used may be designed differently within the scope of the present invention. The software modules may be created using art recognized programming languages, including but not limited to C++, ASP, Java, C#, ASP.NET, or PHP or any combination of known or later developed programming languages that allow the functionality described.

Generally, the software functions of the computerized electronic trading system and method described herein may be programmed via application software, system software or any combination thereof, and may be executable on one or more hardware components within the system, external to the system or some combination thereof. In some embodiments, system and/or application level software may reside on system hardware, various external customer computer systems, or some combination thereof. For example, a netting engine may be implemented with a combination of application software (i.e., a dedicated software routine) which relies on system software (i.e., an operating system and disc drivers) stored on a mainframe computer. Alternately and/or additionally, the netting engine may include system software (i.e., an application programming interface) stored on an external customer computer system (i.e., via an API plugin) and used by a customer application and operating system, for example, to communicate information to other aspects of the computerized electronic trading system and method (i.e., an operating system) through a gateway connection. In some embodiments the netting engine may comprise software to carry out the netting determination.

Similarly, the implementation of various software functions described herein may at times overlap. In various embodiments, some software components may be stored in hardware residing within the system, external to the system or some combination thereof. For example, in some embodiments a software implementation may consist of a stand-alone application installed on a mainframe computer. In other embodiments, certain aspects may reside on customer hardware programmed to communicate with the trading system and method. Accordingly, the present invention should not be limited to the precise systems architecture described, but should be understood to include those variations as would be understood by a person of ordinary skill in the art having the benefits of the present disclosure.

It will also be understood that, although the various embodiments of the present invention described herein are being described in terms of web-based centralized server architecture, a thin client, fat client, or peer-to-peer type arrangement could be substituted for the system architecture described herein and are within the scope of the present invention. Additionally, the programming described herein may be stored in a machine readable form on a computer readable medium, such as a CD-ROM or DVD, and distributed to users for installation on user computers. Alternatively, such programming may be downloaded via network. In either embodiment, communication with the system may be effected across known networks, such as the Internet.

It should be noted that references herein to phrases such as “one embodiment” or “an embodiment” mean that a particular feature, structure or characteristic described in connection with the embodiment is included in at least one embodiment of the invention. The phrases such as “in one embodiment” or “in certain embodiments” in various places in the specification are not necessarily, but may be, referring to the same embodiment. Use of the term “preferred” or “preferably” is intended to indicate a configuration, set-up, feature, process, or alternative that may be perceived by the inventor(s) hereof, as of the filing date, to constitute the best, or at least a better, alternative to other such configurations, set-ups, features, processes, or alternatives. In no way shall the use of the term “preferred” or “preferably” be deemed to limit the scope of the claims hereof to any particular configuration, set-up, feature, process, or alternative.

It will be further appreciated by those skilled in the art that the figures are purely illustrative, and that the system may be implemented in any number of ways, by the actual designers, as long as the functionality as described above, stays intact.

While there have been shown and described fundamental novel features of the invention as applied to the exemplary embodiments thereof, it will be understood that omissions and substitutions and changes in the form and details of the disclosed invention may be made by those skilled in the art without departing from the broad inventive concept thereof. It is the intention, therefore, to be limited only as indicated by the scope of the claims appended hereto. It is also understood, that this invention is not limited to the particular embodiments disclosed, but it is intended to cover modifications within the spirit and scope of the present invention. It is also to be understood that the following claims are intended to cover all of the generic and specific features of the invention herein disclosed and all statements of the scope of the invention that, is a matter of language, might be said to fall there between.

1. A method of spotting and hedging a plurality of electronic trades in order for a plurality of parties to execute and hedge the electronic trades at prices controlled by a common spot, the method comprising:
collecting a plurality of financial product electronic trades, each electronic trade comprising data representing spot-designation of the electronic trade, data representing reference product information and data representing party information, the plurality of agreed electronic trades comprising a first electronic trade having party information including a first party and a second party;
determining an equivalent reference product quantity for at least one collected electronic trade, the at least one collected electronic trade comprising the first electronic trade;
determining net-eligibility of each of the collected electronic trades based on netting criteria;
netting the net-eligible electronic trades;
determining a net quantity comprising the sum of the reference product quantities corresponding to each of the netted electronic trades;
sourcing the net quantity with one or more reference product trades sufficient to satisfy the net quantity based on source selection criteria, at least one identified reference product trade involving a third party;
determining a net level based on net level criteria and the identified one or more reference product trades;
distributing one or more instructions to fill the net quantity at the net level;
determining a common spot based on the net level; and
distributing one or more instructions to fill the multiple electronic trades each at one or more prices controlled by the common spot, the multiple electronic trades comprising at least one netted electronic trade and at least one corresponding electronic trade of the reference product.

2. The method of claim 1 further comprising at least one of:
collecting reference product price tolerance information of a market participant for a reference product corresponding to a collected electronic trade involving the market participant;
collecting reference product threshold information of a dealer for a reference product corresponding to a collected electronic trade involving the dealer;
collecting reference product quantity limit information of a source for a reference product corresponding to a collected electronic trade; and
collecting reference product level information of a source for a reference product corresponding to a collected electronic trade.

3. The method of claim 2, wherein netting criteria comprises at least one of:
a collected electronic trade is net eligible if the system determines the reference product information for the collected electronic trade concerns the same reference product as the reference product information of another collected electronic trade; and
a collected electronic trade is net eligible if the system determines a collected dealer hedge threshold is satisfied by the determined equivalent reference product quantity of the collected electronic trade.

4. The method of claim 2, wherein source criteria comprises at least one of:
a source is selected if the system determines a collected source quantity limit information is satisfied by the determined net quantity; and
a plurality of sources is selected if the system determines a plurality of collected source quantity limit information is collectively satisfied by the net quantity.

5. The method of claim 2, wherein the net level criteria comprises at least one of:
a net level is equal to a collected reference product level information of a source if the system determines the collected source reference product level information satisfies a collected market participant price tolerance information;
a net level is equal to a combination of a plurality of collected source reference product level information, if the combination satisfies a collected market participant price tolerance information.

6. The method of claim 2 wherein:
the net quantity is satisfied by one source;
a reference product price tolerance information of the first market participant is satisfied by a reference product level of the one source;
the equivalent reference product quantity of the first electronic trade satisfies a reference product quantity limit of the first dealer;
the net level is equal to the reference product level of the one source; and
the common spot is equal to the net level.

7. The method of claim 1 wherein the plurality of parties comprises:
the first party comprising a first market participant;
the second party comprising a dealer;
the third party comprising a source.

8. The method of claim 7 wherein the second party and the third party are different entities.

9. The method of claim 1 wherein:
the plurality of spot-designated electronic trades further comprises a second electronic trade having party information including at least one of a second market participant and a second dealer.

10. The method of claim 9 wherein:
the plurality of spot-designated electronic trades further comprises a third electronic trade having party information including at least one of a second market participant, a third market participant, a second dealer, and a third dealer.

11. A computer implemented system for spotting and hedging a plurality of electronic trades in order for a plurality of parties to execute and hedge the electronic trades at prices controlled by a common spot, the system comprising:
a trading system including one or more computer systems capable of analyzing a plurality of spot-designated electronic trades and generating instructions including trade orders to be executed at prices controlled by a common spot, the trading system further including one or more account database for storing data representing a plurality of financial product electronic trades, the plurality of financial product electronic trades including a plurality of spot-designated trades between at least two parties, the plurality of spot-designated trades comprising data representing reference product information and data representing party information;
a plurality of user computers each in electronic communication with the trading system, the plurality of user computers including a plurality of dealer computers each comprising an automated dealer trading system capable of sending data to and receiving data from the trading system, and a plurality of market participant computers capable of sending data to and receiving data from the trading system;
wherein the trading system is communicatively coupled to the user computers, the dealer computers, and the source computers, and the trading system is operative with programming to:
collect a plurality of spot-designated electronic trades, the plurality of electronic trades comprising a first electronic trade having party information including a first party and a second party;
determine an equivalent reference product quantity for at least one collected electronic trade, the at least one collected electronic trade comprising the first electronic trade;
determine net-eligibility of each of the collected electronic trades based on netting criteria;
net the net-eligible electronic trades;
determine a net quantity comprising the sum of the reference product quantities corresponding to each of the netted electronic trades;
source the net quantity with one or more reference product trades sufficient to satisfy the net quantity based on source selection criteria, at least one identified reference product trade involving a third party;
determine a net level based on net level criteria and the identified one or more reference product trades;
distribute one or more instructions to fill the net quantity at the net level;
determine a common spot based on the net level;
distribute one or more instructions to fill the multiple electronic trades each at one or more prices controlled by the common spot, the multiple electronic trades comprising at least one netted electronic trade and at least one corresponding electronic trade of the reference product;
wherein the plurality of parties comprises:
the first party comprises a first market participant;
the second party comprises a dealer; and
the third party comprises a source.

12. The system of claim 11 wherein the trading system is further operative with programming to complete at least one of:
collect reference product price tolerance information of a market participant for a reference product corresponding to a collected electronic trade involving the market participant;
collect reference product threshold information of a dealer for a reference product corresponding to a collected electronic trade involving the dealer;
collect reference product quantity limit information of a source for a reference product corresponding to a collected electronic trade; and
collect reference product level information of a source for a reference product corresponding to a collected electronic trade.

13. The system of claim 12, wherein netting criteria comprises at least one of:
a collected electronic trade is net eligible if the system determines the reference product information for the collected electronic trade concerns the same reference product as the reference product information of another collected electronic trade; and
a collected electronic trade is net eligible if the system determines a collected dealer hedge threshold is satisfied by the determined equivalent reference product quantity of the collected electronic trade.

14. The system of claim 12, wherein source criteria comprises at least one of:
a source is selected if the system determines a collected source quantity limit information is satisfied by the determined net quantity; and
a plurality of sources is selected if the system determines a plurality of collected source quantity limit information is collectively satisfied by the net quantity.

15. The system of claim 12, wherein the net level criteria comprises at least one of:
a net level is equal to a collected reference product level information of a source if the system determines the collected source reference product level information satisfies a collected market participant price tolerance information;
a net level is equal to a combination of a plurality of collected source reference product level information, if the combination satisfies a collected market participant price tolerance information.

16. The system of claim 11, wherein the plurality of parties comprises:
the first party comprising a first market participant;
the second party comprising a dealer;
the third party comprising a source.

17. The system of claim 16 wherein the second party and the third party are different entities.

18. The system of claim 11 wherein:
the plurality of spot-designated electronic trades further comprises a second electronic trade having party information including at least one of a second market participant and a second dealer.

19. The system of claim 11 wherein:
the plurality of spot-designated electronic trades further comprises a third electronic trade having party information including at least one of a second market participant, a third market participant, a second dealer, and a third dealer.

20. The system of claim 11 wherein the net quantity is satisfied by one source.
